(19) United States
(12) Patent Application Publication
(10) Pub. No.: US 2009/0094086 A1
(43) Pub. Date: Apr. 9, 2009

(54) AUTOMATIC ASSIGNMENT FOR DOCUMENT REVIEWING

(75) Inventors: Nicolas Bruno, Redmond, WA (US); Vivek R. Narasayya, Redmond, WA (US); Surajit Chaudhuri, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/866,417

(22) Filed: Oct. 3, 2007

(51) Int. Cl. G06Q 10/00; G06F 3/00

(52) U.S. Cl. 705/9; 715/700

(57) ABSTRACT

Assignment algorithm for automatically making assignments between documents and document reviewers for a review process. If the automated assignments need adjusting, a coordinator can manually refine the assignment(s). The assignment algorithm facilitates the automated assignment process based on inputs related to a constraint and/or a preference. The constraints and preferences include, but are not limited to, a conflict of interest, a minimum number of reviews, a maximum number of submissions, a partial assignment, bidding preferences, and health metrics. Once the assignments have been made, histograms can be generated that present an overview of certain health metrics, further allowing refinement of the assignment process.

### BACKGROUND

Reviewing application documents is an important part of the workflow of an application. Examples of such applications include selecting papers for an academic conference or workshop, selecting candidates to award a Fellowship, and requests for proposal (RFPs), in which one or more grant proposals need to be selected.

An assignment step in these applications ensures that each submission is reviewed by an appropriate set of reviewers. Intuitively, for each submission the reviewers that are most qualified to review that submission should be the users who are assigned the submission. Different submissions can pertain to different subject areas, and different reviewers can have different areas of expertise. Additionally, there may be fixed requirements such as a minimum number of reviews per document or certain limits on the number of documents some reviewers are assigned. These factors make the assignment step a challenging process for a coordinator.

In these applications, there is typically an overall coordinator responsible for managing the application workflow (e.g., Program Chair in a conference, Head of a Fellowship committee/RFP). In addition, there is a group of reviewers (e.g., the Program Committee in a conference, Members of the Fellowship committee/RFP) responsible for reviewing one or more submissions (e.g., papers, fellowship applications, grant proposals) and submitting feedback on the submission. The final decision of which subset of submissions to accept is made by the coordinator based on the reviews submitted by the reviewers.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Disclosed herein is a framework that includes a method for automatically performing the assignment step. The method can take into account the requirements of applications such as constraints (a certain submission should not be assigned to particular reviewer), preferences (a reviewer prefers to review one submission over another), as well a partial assignment (e.g., the coordinator has already performed certain assignments previously which need to be preserved). This automatic assignment method can be used by the coordinator to produce an assignment which can then be manually refined, as desired.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and equivalents. Other advantages and novel features will become apparent from the following detailed description when considered in conjunction with the drawings.

### BRIEF DESCRIPTION OF THE DRAWINGS

FIG. 1 illustrates a computer-implemented document reviewing system.

FIG. 2 illustrates an alternative system that processes preferences and quality metrics.

FIG. 3 illustrates an example of the constraints and preferences that can be employed for the document reviewing process.

FIG. 4 illustrates a graph generated to analyze the review process.

FIG. 5 illustrates a set of histogram charts for reviewer health and author health.

FIG. 6 illustrates a method of reviewing documents.

FIG. 7 illustrates an alternative method of reviewing submissions.

FIG. 8 illustrates a method of constraints processing in accordance with the assignment algorithm.

FIG. 9 illustrates an exemplary UI where the automatic assignment functionality is exposed as a wizard that includes four steps.

FIG. 10 illustrates an exemplary UI that presents more details associated with paper selection.

FIG. 11 illustrates an exemplary UI that presents more details associated with constraining the minimum number of reviewers that should be assigned to each paper.

FIG. 12 illustrates an exemplary UI that presents more details associated with constraining the maximum number of papers that a reviewer can be assigned.

FIG. 13 illustrates an exemplary UI that presents more details associated running the automatic assignment algorithm according to the current settings, and the results are presented to the Chair.

FIG. 14 illustrates a block diagram of a computing system operable to execute the disclosed document assignment architecture.

### DETAILED DESCRIPTION

The disclosed architecture includes an assignment algorithm for automatically assigning papers to paper reviewers for a submission (a paper) review process. If the automated assignments need adjusting, a submission coordinator can manually refine the assignment(s). The assignment algorithm facilitates the automated assignment process based on inputs related to a constraint and/or a preference. As will be described in more detail, the constraints and preferences include, but are not limited to, a conflict of interest, a minimum number of reviews, a maximum number of assignments per reviewer, a partial assignment, and bidding preferences, for example. Additionally, health metrics can be computed for analyzing quality of a given assignment.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

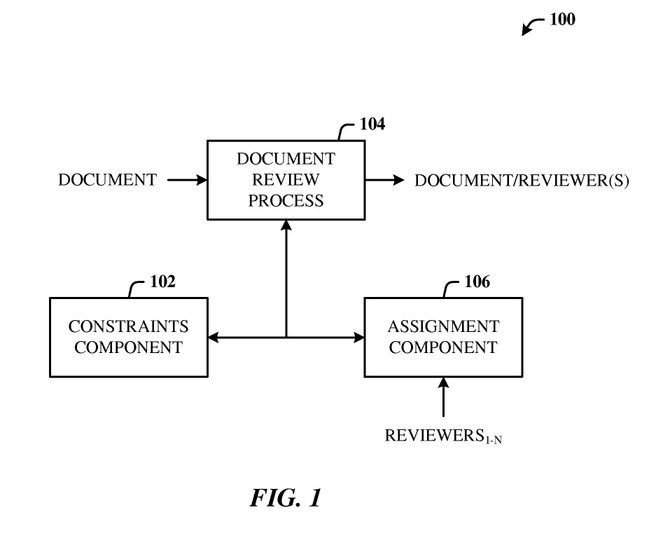

FIG. 1 illustrates a computer-implemented document reviewing system 100. The system 100 includes a constraints component 102 for applying constraints to a review process 104 of a document, and an assignment component 106 for automatically assigning one or more reviewers (denoted REVIEWERS_{1-N}) to the review process 104 based on the constraints.

The document, paper, request for proposal (RFP), etc., received for the review process will typically include metadata (e.g., author(s), pages, document format, category of science, subject matter, title, proceeding for presentation, etc.) which can be input to the document review process 104. The review process coordinator can then review this metadata entered into the review system (or program) in order to make an adjustment that may be needed before, during or after the review process. The metadata can also be used by the reviewers to bid on documents to review and to conflict reviewers from reviewing the document.

In one implementation, the document is uploaded manually into the review system and constraints can be specified manually and globally as well. For instance, the coordinator can stipulate that each paper is to be reviewed by at least three reviewers. Additionally, stipulations can include that a set of the reviewers review no more than ten papers but another set of reviewers must review at least thirteen but no more than fifteen in a given time period. The coordinator can also stipulate that one reviewer will not be allowed to review a paper. These and other constraints can be imposed on an individual basis, on groups of reviewers, etc.

In another implementation, document metadata can be obtained automatically when the document is received in an electronic format and processed according to preconfigured rules and/or polices set by the coordinator. For example, if the coordinator knows in advance that a paper will be received and has knowledge of the metadata, the coordinator can configure the reviewers, settings, constraints, etc., before arrival of the paper. As another example, the paper author can be required to complete a template of information that includes the metadata. Thus, the template can be automatically received into the review program. Once received into the system, the review process automatically assigns, distributes, invokes preferences, bids, etc., to initiate the review process. As before, thereafter, the coordinator can manually adjust the assignments as desired. This manual adjustment can also include invoking other rules that automatically execute to impose other constraints, preferences, etc., rather than the coordinator having to adjust each aspect of the program separately.

Preferences, however, are generally configured the particular reviewer, although it can be made configurable that the coordinator provides input as to preferences as well, in a global manner. For example, the review program can access reviewer personal information such as an electronic calendar that stores meetings, vacations, etc., which when processed will affect assignment of that reviewer to a paper. If a previously-assigned reviewer was removed from a current assignment, this reviewer can then be prioritized for the next suitable paper input for review. These are just a few examples of the flexibility that can be employed in managing the document review process.

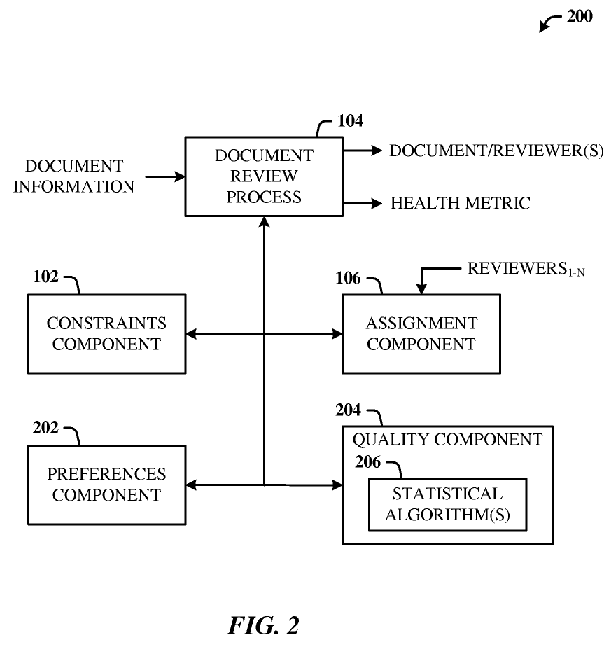

FIG. 2 illustrates an alternative system 200 that processes preferences and quality metrics. The system 200 includes the constraints component 102 and assignment component 106 of FIG. 1, but now includes a preferences component 202 for introducing preferences into the document review process 104 and a quality component 204 for measuring quality of the overall review process (“health metrics”). Accordingly, reviewer preferences can now be imposed in the document review process 104 by the individual reviewers. The quality component 204 uses a statistical algorithm 206 to analyze the review process 104 (e.g., assignment quality). Thus, a health metric can be output that measures various aspects such as reviewer health and author health, for example.

There are at least two measures of assignment quality metric (or health metric) that are interesting. A first metric measures the quality with respect to submissions. Intuitively, a submission has the best quality if it is assigned to the reviewers that placed the highest bid for that submission. A second metric measures the assignment quality with respect to reviewers. Intuitively, a reviewer has the best quality when assigned the papers for which the reviewer placed the highest bids. A good assignment should have high quality according to both these metrics.

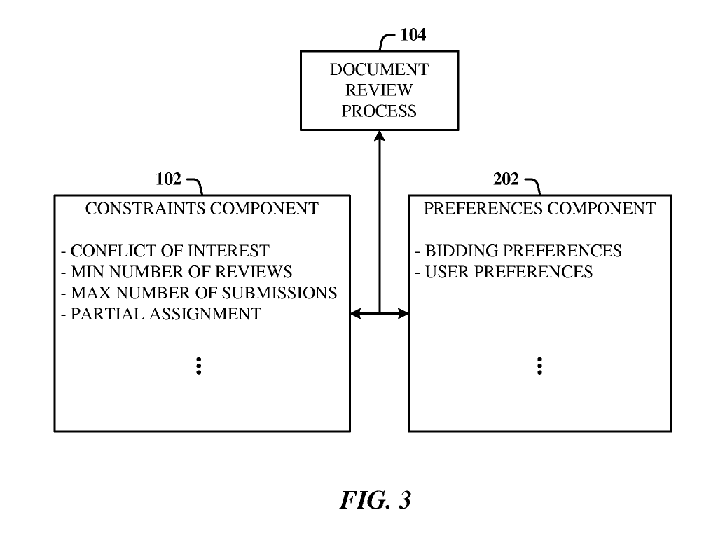

FIG. 3 illustrates an example of the constraints and preferences that can be employed for the document reviewing process. The constraints component 102 stores and imposes a constraint (an element that must be obeyed by the assignment step) the preferences component 202 allows a preference (an element could be obeyed by the assignment step). Note that the assignment obeys all specified constraints for the assignment to be considered feasible. Examples of constraints that can be employed include the following.

Conflict-of-interest (COI) constraint. A COI is defined between a submission (or paper) S and reviewer R, and states that reviewer R is not allowed to review submission S. As an example, in a conference a submission authored by a person from a particular organization can have a COI with a reviewer from the same organization. In general, a set of tuples (Submission, Reviewer) can be specified.

Minimum number of reviews constraint. This constraint states that a particular submission S should be assigned to at least a specified number of reviewers. For example, in a conference, a Program Chair may desire that each paper is reviewed by at least five members of the Program Committee.

Maximum number of submissions constraint. This constraint states that a particular reviewer R should be assigned no more than a specified number of submissions S. For example, in a conference, the Program Chair may want that each Program Committee member review no more than fifteen papers.

Partial Assignment constraint. This constraint states that a specified set of assignments should not be violated by the assignment method. A submission S must be assigned to reviewer R. For example, if the coordinator performs two rounds of reviewing and the coordinator can ensure that the assignments made in the first round are preserved during the second round.

An example of a preference is a bidding preference. The assignment method can leverage the preferences specified by reviewers for each paper and/or block of papers via a bidding process. During the bidding process (which can occur prior to the assignment process), each reviewer specifies a bid (e.g., a number on a predefined scale such as 0-5) for each submission that indicates the willingness/interest of the reviewer to review that submission (e.g., 0 is low willingness and 5 is a high willingness). The bid is typically placed based on the reviewer's expertise in the subject area/material pertaining to that submission.

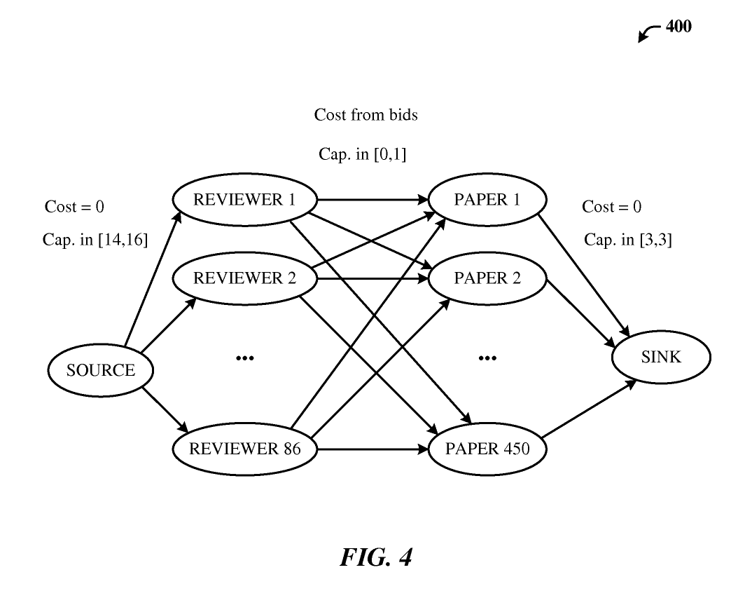

FIG. 4 illustrates a graph 400 generated to analyze the review process. The following description is in the context and terminology for a conference/workshop workflow (e.g., a submission is a paper). However, it is intended not to be limiting in any way, since the description can also apply to the review of RFPs, resumes, objects, etc.

Assume the following scenario. There are P papers and R reviewers. Each paper must be reviewed by Nr reviewers and each reviewer should review between Np-lo and Np-hi papers. Additionally, b(i,j) is the original bid of the i-th reviewer to the j-th paper, and coi(i,j) is true if and only if the i-th reviewer has a conflict of interest with the j-th paper. To make the example scenario more concrete, further assume that b(i,j) is a number from zero (no interest) to five (very interested).

The assignment algorithm produces a mapping from reviewers to papers that (i) satisfy all the constraints, and (ii) maximizes the bids of the assigned papers. There are different optimization functions (e.g., maximize the sum of bids, or maximize the smallest bid, etc.). The disclosed assignment solution maps the assignment problem into a min-cost/max-flow network problem as follows.

First, a bipartite graph is formed between reviewers and papers, omitting edges between a reviewer and a paper where a COI exists. Source and sink nodes are added, with edges from the source node to all reviewers and from all papers to the sink. Three numbers are then assigned to each edge: minimum capacity x, maximum capacity y (denoted Cap. in [x, y]), and cost (denoted Cost).

For each edge between the source and a reviewer, the minimum and maximum capacity is set equal to the minimum and maximum number of papers that the reviewer should review; the cost is set to zero. For each edge between a paper and the sink, the minimum and maximum capacity is set equal to the number of reviewers that each paper should get, and a cost of zero. Finally, for each edge between a paper and a reviewer, the minimum capacity is set to zero, the maximum capacity is set to one, and the cost as the negative normalized bid of such reviewer and paper. Normalized bids are obtained by scaling all bids so that the sum of all bids of each reviewer is a constant.

When interpreting the graph 400 as a network, the assignment problem reduces to obtain a maximum flow with the minimum possible cost. In fact, each unit of flow is considered to correspond to a review. If the problem is feasible, the maximum flow assigns the correct number of papers to each reviewer (to satisfy all constraints) while minimizing the cost (which translates into maximizing the sum of normalized bids).

A consequence of mapping the assignment problem to a network problem is that the constraints and preferences can be easily incorporated into the main algorithm. First, a different number of reviewers can be assigned to individual papers by adjusting the minimum and maximum capacity of the edges between the corresponding papers and the sink. Second, the range of papers that some reviewers must analyze can be adjusted by changing the minimum and maximum capacity of the edges between the source and the corresponding reviewers. Third, a partial assignment can be froze by (i) eliminating the edges in the assignment from the graph, and (ii) adjusting down the capacities of the remaining papers and reviewers after removing the partial assignment. After obtaining a solution to the reduced problem, the partial assignment is unioned with the new solution to obtain the desired result. Not that there are larger costs associated with a smaller number of bids for a paper.

In one implementation, the assignment algorithm uses a modification of a Ford-Fulkerson algorithm, in which each augmenting path is obtained as the shortest augmenting path from the source to the sink. Since paths can contain negative values, a Bellman-Ford algorithm can be used to compute shortest paths.

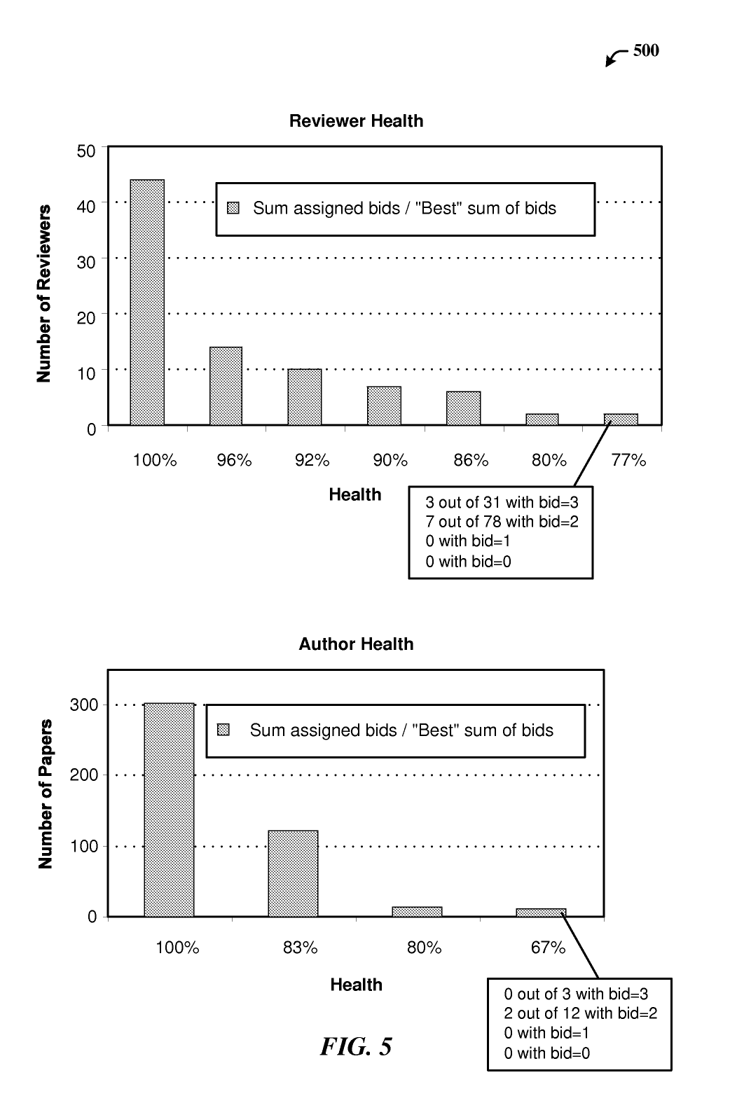

FIG. 5 illustrates a set of histogram charts 500 for reviewer health and author health. After an assignment is performed (either manually, using the algorithm in the previous section, or a combination of both), a set of metrics that evaluates the quality of the assignment and hints as to what might not be desirable and should be refined are provided. Intuitively, a good assignment should have high quality from the point of view of both reviewers and documents.

Following is a set of metrics that can assist a coordinator in evaluating different assignments. For reviewers, HR(r)=sum of assigned bids/sum of top-k bids for r, where k is the number of assigned papers. Thus, for a given reviewer r, this is a number between zero and one, where one means that the papers assigned to reviewer r have the maximum possible bids for r. For papers, HP(p)=sum of assigned bids/sum of top-k bids for p.

These metrics can be aggregated to obtain higher-level information as follows:

GHR=(avg/min)HR(r), for all reviewers

GHP=(avg/min)HP(p), for all papers

And finally GH=(min/avg)(GHR,GHP)

In addition to the above aggregates, an interactive means is provided to explore the results and feedback is provided to the main algorithm in the form of refinements (e.g., fixing some review, changing parameters, etc.). For instance, the histogram 500 of HP and HR shows the values for all the papers and respective reviewers. The coordinator can, at a glance, see that most of the reviewers have a health rating greater than 0.9. Additionally, the coordinator can drill down and see that for the reviewer at 0.77, no paper was given a bid of 0 or 1. Note that in this particular example, the bids range from zero to three, which can be a configurable parameter.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

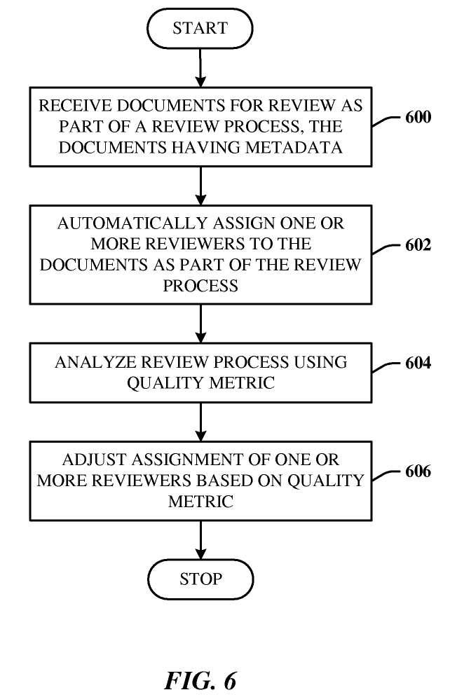

FIG. 6 illustrates a method of reviewing documents. At 600, documents for review are received as part of a review process. Each document includes corresponding metadata such as author, title, proceeding, subject matter, etc., that can be utilized as part of the assignment process. At 602, one or more reviewers are automatically assigned to the documents as part of the review process. At 604, the review process is analyzed for quality using a quality metric. At 606, the assignment of the one or more reviewers can be adjusted based on the quality metric.

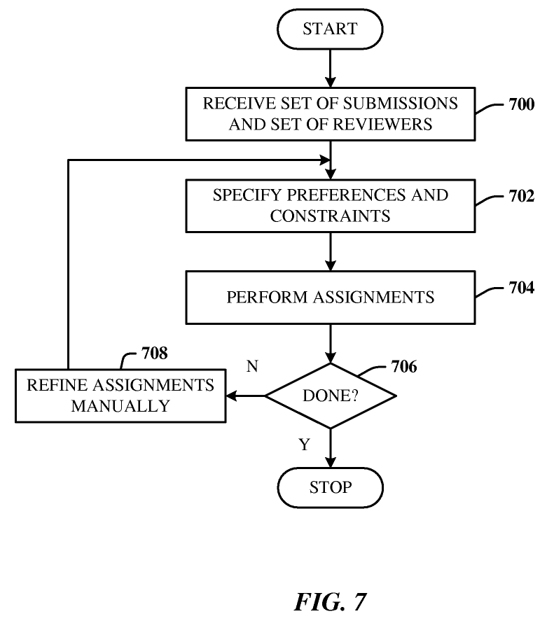

FIG. 7 illustrates an alternative method of reviewing submissions. At 700, a set of submissions and a set of reviewers are received. At 702, preferences and/or constraints are specified. At 704, the assignments are made of the reviewers to the submissions. At 706, a check is made to determine if the assignment process has completed. If not, flow is from 706 to 708 to manually refine the assignments, and then to reprocess the constraints and/or preferences as another check to ensure the manual adjustment is validated accordingly.

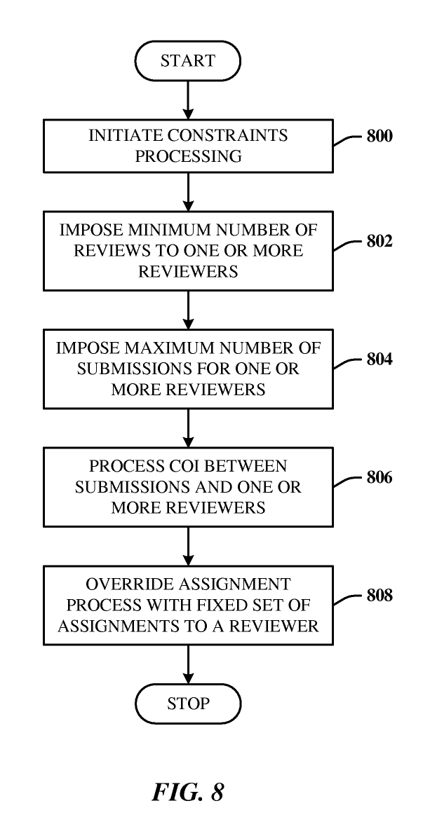

FIG. 8 illustrates a method of constraints processing in accordance with the assignment algorithm. At 800, constraints processing is initiated. At 802, a constraint is specified that imposes a minimum number of reviews to one or more of the reviewers. This can be a global setting and/or a specific reviewer setting. At 804, a constraint is specified that imposes a maximum number of submissions for the one or more reviewers. This can be a global setting and/or a specific reviewer setting. At 806, a COI constraint is set and processed between submissions and the one or more reviewers. This can be a group setting and/or a specific reviewer setting. In other words, groups of reviewers can be stipulated as having conflicts for the particular submission. At 808, a certain assignment process can be overridden with a fixed set of assignments to a reviewer (a partial assignment constraint).

Following is a set of screenshots of a user interface (UI) that illustrate in one implementation how the assignment functionality can be made in an application.

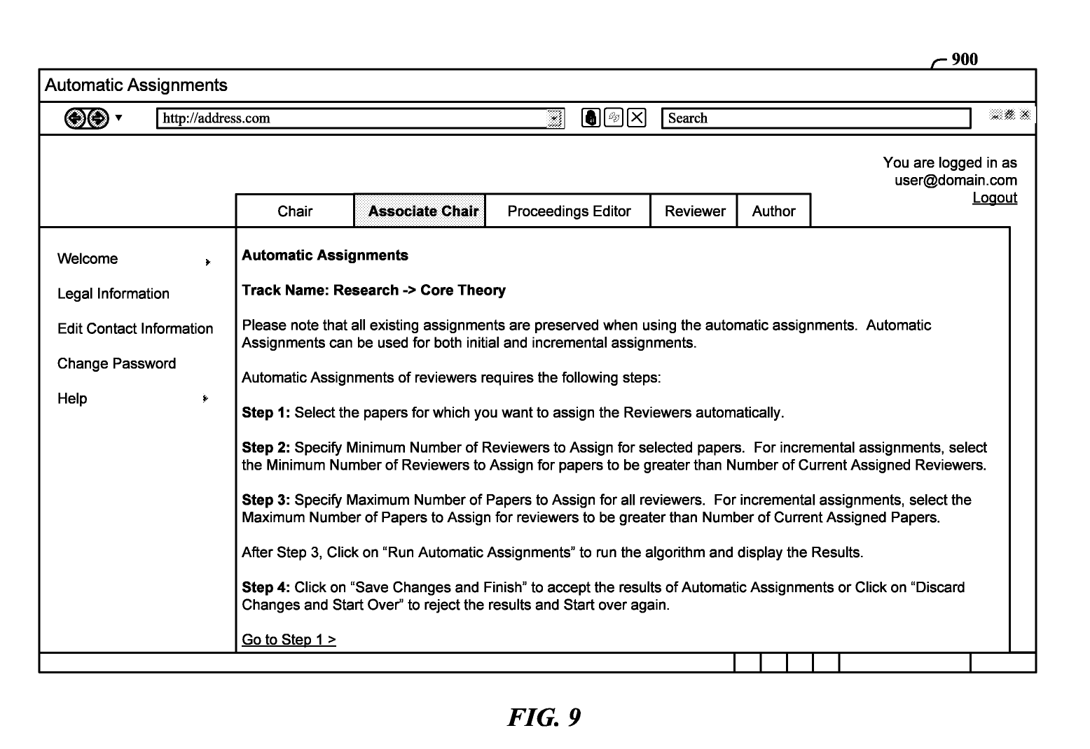

FIG. 9 illustrates an exemplary UI 900 where the automatic assignment functionality is exposed as a wizard that includes four steps. The steps illustrated are selecting papers for automatic review assignment, specifying the minimum number of reviewers to assign to a given paper, specifying a maximum number of papers to assign for all reviewers, and then running the assignment algorithm and presenting results.

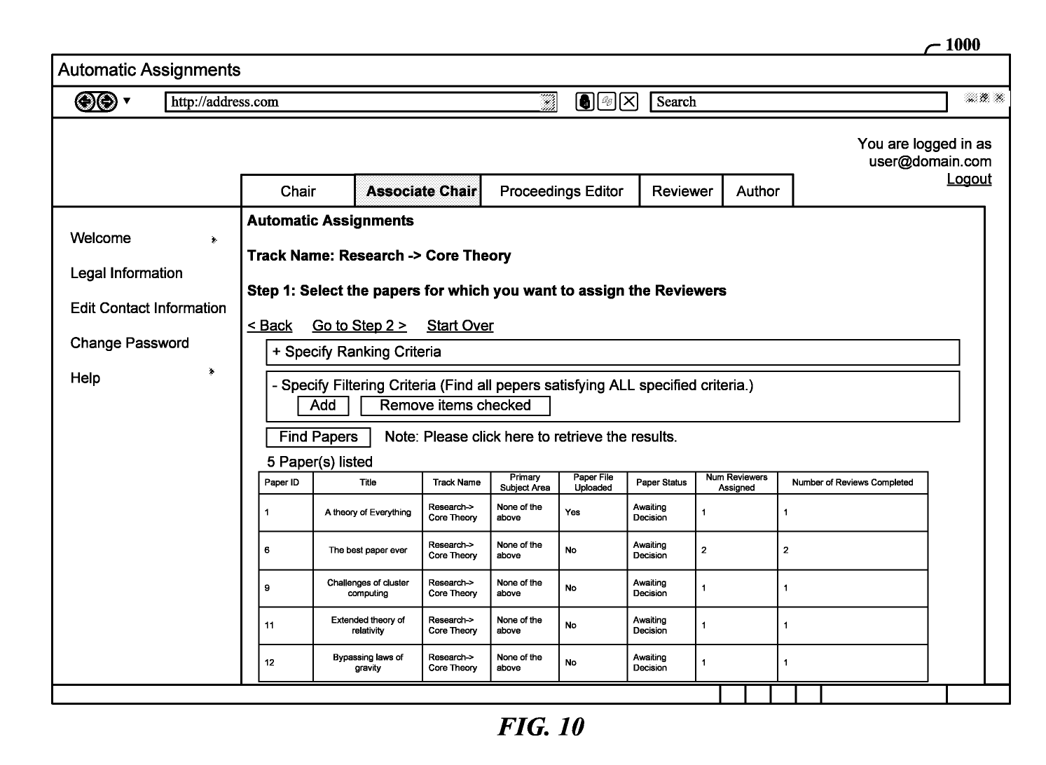

FIG. 10 illustrates an exemplary UI 1000 that presents more details associated with paper selection. Here, the Chair person (also referred to as the coordinator) selects the set of papers for which automatic assignments should be applied. Ranking and filtering criteria can be specified via the UI.

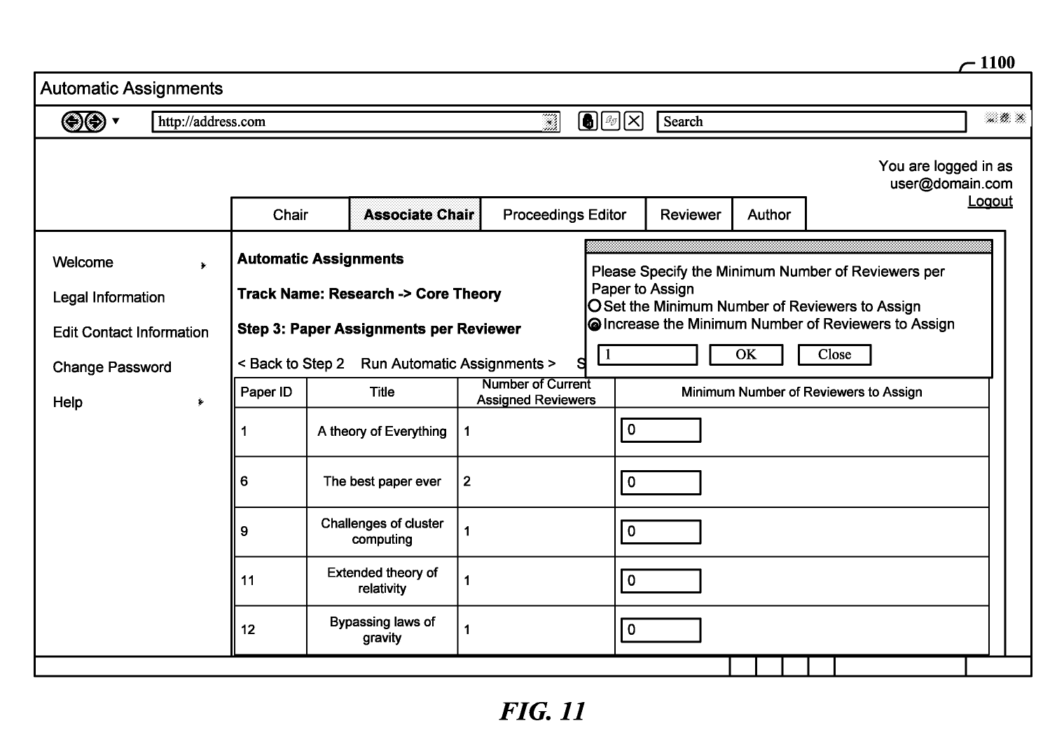

FIG. 11 illustrates an exemplary UI 1100 that presents more details associated with constraining the minimum number of reviewers that should be assigned to each paper. Note that this number can be specified on a per paper basis. Additionally, this constraint can be specified in an incremental mode (existing assignments are preserved) or in the full mode where existing assignments are not preserved.

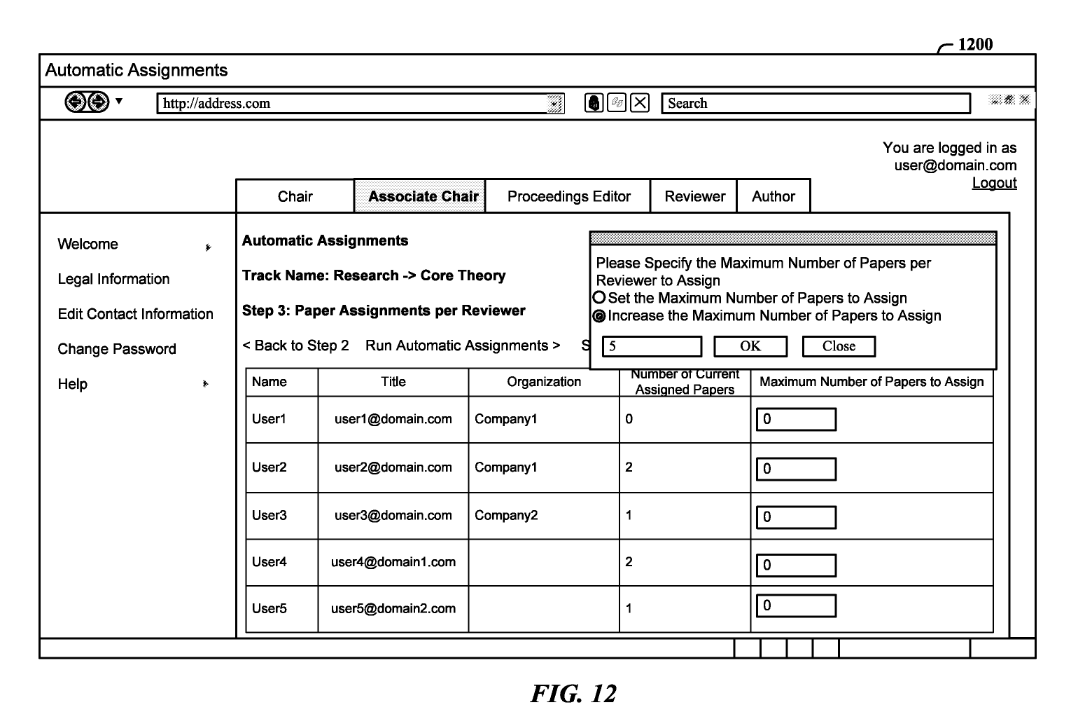

FIG. 12 illustrates an exemplary UI 1200 that presents more details associated with constraining the maximum number of papers that a reviewer can be assigned. Note once again that this number can be specified on a per reviewer basis.

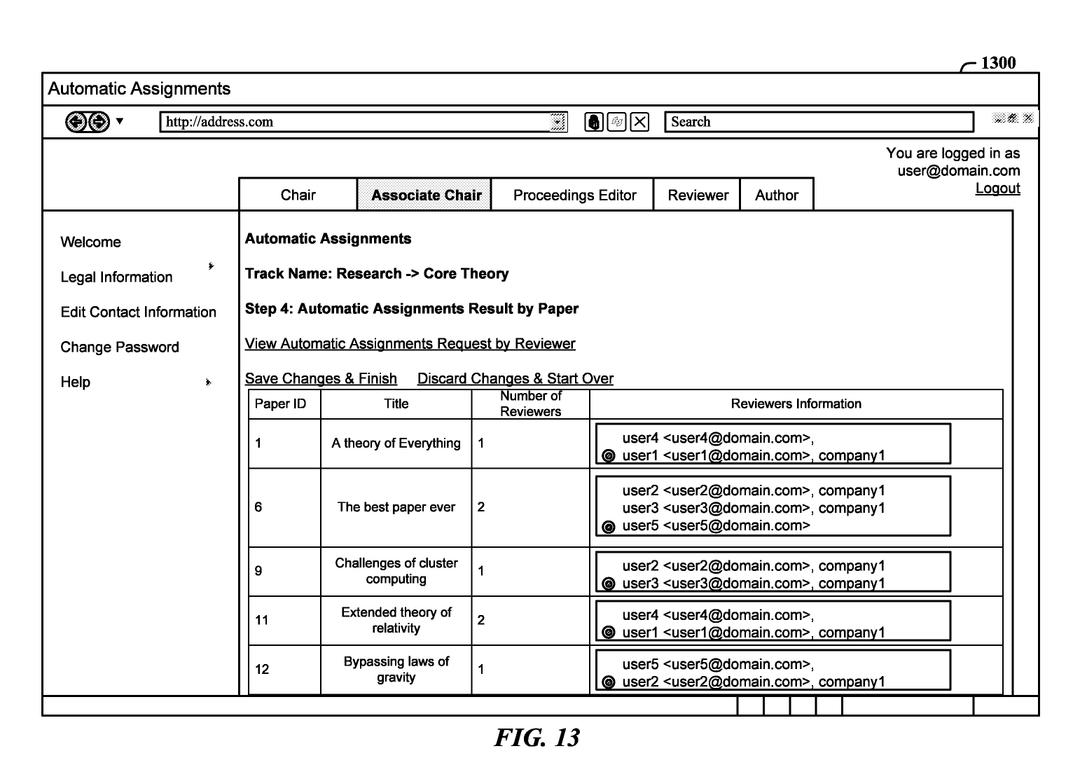

FIG. 13 illustrates an exemplary UI 1300 that presents more details associated running the automatic assignment algorithm according to the current settings, and the results are presented to the Chair; who can either accept or discard the proposed assignment.

While certain ways of displaying information to users are shown and described with respect to certain figures as screenshots, those skilled in the relevant art will recognize that various other alternatives can be employed. The terms “screen,” “screenshot”, “webpage,” “document”, and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

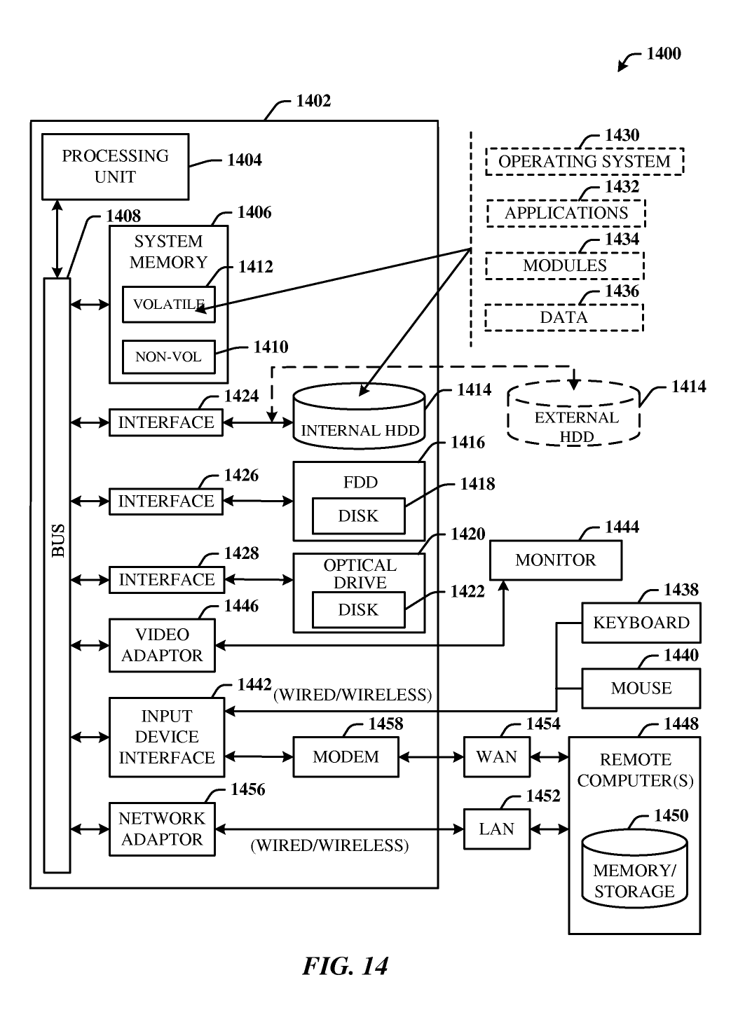

Referring now to FIG. 14, there is illustrated a block diagram of a computing system 1400 operable to execute the disclosed document assignment architecture. In order to provide additional context for various aspects thereof, FIG. 14 and the following discussion are intended to provide a brief, general description of a suitable computing system 1400 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 14, the exemplary computing system 1400 for implementing various aspects includes a computer 1402 having a processing unit 1404, a system memory 1406 and a system bus 1408. The system bus 1408 provides an interface for system components including, but not limited to, the system memory 1406 to the processing unit 1404. The processing unit 1404 can be any of various commercially available processors. Dual microprocessors and other multi-processor architectures may also be employed as the processing unit 1404.

The system bus 1408 can be any of several types of bus structure that may further interconnect to a memory bus (with or without a memory controller), a peripheral bus, and a local bus using any of a variety of commercially available bus architectures. The system memory 1406 can include non-volatile memory (NON-VOL) 1410 and/or volatile memory 1412 (e.g., random access memory (RAM)). A basic input/output system (BIOS) can be stored in the non-volatile memory 1410 (e.g., ROM, EPROM, EEPROM, etc.), which BIOS contains the basic routines that help to transfer information between elements within the computer 1402, such as during start-up. The volatile memory 1412 can also include a high-speed RAM such as static RAM for caching data.

The computer 1402 further includes an internal hard disk drive (HDD) 1414 (e.g., EIDE, SATA), which internal HDD 1414 may also be configured for external use in a suitable chassis, a magnetic floppy disk drive (FDD) 1416, (e.g., to read from or write to a removable diskette 1418) and an optical disk drive 1420, (e.g., reading a CD-ROM disk 1422 or, to read from or write to other high capacity optical media such as a DVD). The HDD 1414, FDD 1416 and optical disk drive 1420 can be connected to the system bus 1408 by a HDD interface 1424, an FDD interface 1426 and an optical drive interface 1428, respectively. The HDD interface 1424 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 1402, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 1412, including an operating system 1430, one or more application programs 1432, other program modules 1434, and program data 1436. The one or more application programs 1432, other program modules 1434, and program data 1436 can include the constraints component, assignment component 106, preferences component 202, quality component 204 and statistical algorithm(s) 206, for example.

All or portions of the operating system, applications, modules, and/or data can also be cached in the volatile memory 1412. It is to be appreciated that the disclosed architecture can be implemented with various commercially available operating systems or combinations of operating systems.

A user can enter commands and information into the computer 1402 through one or more wire/wireless input devices, for example, a keyboard 1438 and a pointing device, such as a mouse 1440. Other input devices (not shown) may include a microphone, an IR remote control, a joystick, a game pad, a stylus pen, touch screen, or the like. These and other input devices are often connected to the processing unit 1404 through an input device interface 1442 that is coupled to the system bus 1408, but can be connected by other interfaces such as a parallel port, IEEE 1394 serial port, a game port, a USB port, an IR interface, etc.

A monitor 1444 or other type of display device is also connected to the system bus 1408 via an interface, such as a video adaptor 1446. In addition to the monitor 1444, a computer typically includes other peripheral output devices (not shown), such as speakers, printers, etc.

The computer 1402 may operate in a networked environment using logical connections via wire and/or wireless communications to one or more remote computers, such as a remote computer(s) 1448. The remote computer(s) 1448 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1450 is illustrated. The logical connections depicted include wire/wireless connectivity to a local area network (LAN) 1452 and/or larger networks, for example, a wide area network (WAN) 1454. Such LAN and WAN networking environments are commonplace in offices and companies, and facilitate enterprise-wide computer networks, such as intranets, all of which may connect to a global communications network, for example, the Internet.

When used in a LAN networking environment, the computer 1402 is connected to the LAN 1452 through a wire and/or wireless communication network interface or adaptor 1456. The adaptor 1456 can facilitate wire and/or wireless communications to the LAN 1452, which may also include a wireless access point disposed thereon for communicating with the wireless functionality of the adaptor 1456.

When used in a WAN networking environment, the computer 1402 can include a modem 1458, or is connected to a communications server on the WAN 1454, or has other means for establishing communications over the WAN 1454, such as by way of the Internet. The modem 1458, which can be internal or external and a wire and/or wireless device, is connected to the system bus 1408 via the input device interface 1442. In a networked environment, program modules depicted relative to the computer 1402, or portions thereof, can be stored in the remote memory/storage device 1450. It will be appreciated that the network connections shown are exemplary and other means of establishing a communications link between the computers can be used.

The computer 1402 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented document reviewing system, comprising:
a constraints component for applying constraints to a review process of a document; and
an assignment component for automatically assigning one or more reviewers to the review process based on the constraints.

2. The system of claim 1, wherein the assignment component includes a health metric that measures quality associated with a submission.

3. The system of claim 1, wherein the assignment component includes a health metric that measures quality associated with the one or more reviewers.

4. The system of claim 1, wherein the constraints include a conflict-of-interest constraint that prevents a reviewer from reviewing the document due to a conflict of interest.

5. The system of claim 1, wherein the constraints include a minimum-number-of-reviewers constraint which specifies that the document is to be reviewed by a minimum number of reviewers.

6. The system of claim 1, wherein the constraints include a maximum-number-of-submissions constraint which specifies that a reviewer cannot review more than a specified number of documents.

7. The system of claim 1, wherein the constraints include a partial assignment constraint which preserves a first set of assignments of a first round of the review process to a second round of the review process.

8. The system of claim 1, further comprising a preferences component for processing preferences specified by a reviewer for the review process.

9. The system of claim 8, wherein the preferences include bidding preferences for bidding on review of the document based on an interest or willingness to review the document.

10. The system of claim 1, further comprising a user interface for configuring constraints and assignments for the review process.

11. A computer-implemented method of reviewing documents, comprising:
receiving documents for review as part of a review process, the documents including corresponding metadata;
automatically assigning one or more reviewers to the documents as part of the review process;
analyzing the review process using a quality metric; and
adjusting assignment of the one or more reviewers based on the quality metric.

12. The method of claim 11, further comprising:
generating an assignment mapping between the one or more reviewers and the documents;
computing a capacity parameter for the one or more reviewers to review the documents; and
computing a cost value associated with a reviewer bidding to review a document.

13. The method of claim 11, further comprising analyzing the review process based on a statistical algorithm.

14. The method of claim 11, further comprising generating a graph of links between the one or more reviewers and the documents, the graph in the form of a minimum-cost and maximum-flow network problem that eliminates links where conflicts of interest exist between a reviewer and a document.

15. The method of claim 11, further comprising presenting a hint on improving quality of the review process.

16. The method of claim 11, further comprising establishing a minimum number of reviewers for the document, which is a professional paper, and imposing a maximum number of the papers that a review can review.

17. The method of claim 11, further comprising overriding the assignment by imposing a partial assignment constraint to the one or more reviewers.

18. The method of claim 11, further comprising processing a bid preference from the one or more reviewers based on an interest or willingness to review the document.

19. The method of claim 11, wherein the automatic assignment of the one or more reviewers is reviewed for manual adjustment by a coordinator.

20. A computer-implemented system, comprising:
computer-implemented means for receiving documents for review as part of a review process, the documents including corresponding metadata;
computer-implemented means for automatically assigning one or more reviewers to the documents as part of the review process;
computer-implemented means for analyzing the review process using a quality metric; and
computer-implemented means for adjusting assignment of the one or more reviewers based on the quality metric.
